(19) United States
(12) Patent Application Publication
(10) Pub. No.: US 2007/0240179 A1
(43) Pub. Date: Oct. 11, 2007

(54) Smart channel-surfer system

(76) Inventor: Robert Thomas Lavigne, The Woodlands, TX (US)

Correspondence Address: John R. Casperson, PO Box 2174, Friendswood, TX, 77549, US

(21) Appl. No.: 11/390,857

(22) Filed: Mar. 28, 2006

(51) Int. Cl. H04H 9/00; H04N 5/50

(52) U.S. Cl. 725/14; 348/731; 348/734

(57) ABSTRACT

The invention provides means and method for monitoring a viewer's television use and ranking the channels in order of preference, and then initiating a channel surfing sequence by channel based on order of preference. An apparatus according to the invention comprises a television set, a tuner, a remote control, a receiver for the remote control signals, a computer memory, a microprocessor, a timer and computer instructions. The television set is capable for accessing and displaying a plurality of television channels, one at a time. The tuner is associated with for selecting a channel to be viewed. The microprocessor is associated with the tuner for signaling the tuner to select the desired channel. The receiver is for receiving command signals from the remote control and relaying the command signals to the microprocessor. The computer memory is associated with the microprocessor for storing a historical channel data database adequate to rank the plurality of channels in order of most watched to least watched. The timer signals the microprocessor to update the database with current channel information. The computer instructions are operatively associated with the microprocessor to enable the sequential display of at least a subset of the plurality of channels, one at a time, in descending order, from most watched channel to least watched channel, or in ascending order, from least watched to most watched channel, responsive to command signals from the television remote control.

### FIELD OF THE INVENTION

The invention provides means and method for monitoring a viewer's television use and ranking the channels in order of preference, and then initiating a channel surfing sequence by channel based on such order of preference.

### BACKGROUND OF THE INVENTION

Current TV signal providers, mainly cable and satellite providers, provide the viewer with dozens of channels, many of them directed toward different specific narrow audiences. The number of available channels can only be expected to increase. Because most viewers are only interested in a small percentage of the available channels, it is necessary to search past many channels that are unlikely to be of interest to bring up the candidate channels that are likely to be of interest. A system for surfing through only the channels likely to be of interest is not available and would be very desirable.

Viewer preferences vary by viewer, day of week, and time. They also vary over time. A system which provides for personalized surfing preference taking at least some of these factors into account would be further desirable.

Most TV surfing is done with a remote control. A system which provides for personalized surfing with a remote control would be still further desirable.

### OBJECTS OF THE INVENTION

It is an object of this invention to provide a means for tracking TV viewing according to the past viewing preferences of the individual viewer and ranking them from a most watched channel to a least watched channel, and to further provide a means for selecting the preference-ordered channels in their preferential order.

It is another object of this invention to provide a tracking means that can reside in a cable or satellite set top box, inside a television remote control, or inside the television itself.

It is a further object of this invention to provide a remote control with a smart-surf button and associated means for actuating the means for selecting the preference-ordered channels.

### SUMMARY OF THE INVENTION

One embodiment of the invention provides a television apparatus with computer-implemented functions. The apparatus comprises a television set, a tuner, a remote control, a receiver for the remote control signals, a computer memory, a microprocessor, a timer and computer instructions. The television set is capable of accessing and displaying a plurality of television channels, one at a time. The tuner is associated with the television set for selecting a channel to be viewed. The microprocessor is associated with the tuner for signaling the tuner to select the desired channel. The receiver is for receiving command signals from the remote control and relaying the command signals to the microprocessor. The computer memory is associated with the microprocessor for storing a historical channel data database adequate to rank the plurality of channels in order of most watched to least watched. The timer signals the microprocessor to update the database with current channel information. The computer instructions are operatively associated with the microprocessor to enable the sequential display of at least a subset of the plurality of channels, one at a time, in descending order, from most watched channel to least watched channel, or in ascending order, from least watched channel to most watched channel, responsive to command signals from the television remote control.

Another embodiment of the invention provides an automated process for selecting a most received signal for a device selected from the group consisting of a television set, a radio, and an internet computer. The device has associated therewith a signal-responsive tuner for selecting a signal to be received and a detector for detecting the signal being received and producing a current signal representative of the signal reception. The method comprises receiving the current signal in a data processing device, storing, in a computer memory device associated with the data processing device, historical signal data adequate to determine a most received signal for the device, determining, in the data processing device, the most received signal, and signaling the tuner to access the most received signal based on the determination.

In another embodiment of the invention, there is provided a method for surfing favorite TV channels. The television set is capable of accessing and displaying a plurality of television channels, one at a time. The television set has associated therewith a signal-responsive tuner for selecting a channel to be viewed and a detector for detecting the channel being viewed and producing a current channel signal representative of such channel. The current channel signal is received in a data processing device. A computer memory device associated with the data processing device stores channel data adequate to represent at least a subset of the plurality of television channels based on time spent viewing the channel. The subset comprises the television channels which are most viewed. The data processing device is provided with machine-readable instructions to enable the sequential display of the at least the subset of the plurality of channels, one at a time, in an ascending or descending priority sequence, based on time spent viewing the channels. A command signal is provided to the data processing device to execute the machine readable instructions and display a next channel of the at least a subset of the plurality of channels in the priority sequence.

### BRIEF DESCRIPTION OF THE DRAWINGS

FIG. 1 schematically illustrates an apparatus according to one embodiment of the invention.

FIG. 2 schematically illustrates a portion of the apparatus shown in FIG. 1.

FIG. 3 illustrates a logic flow chart showing a computer routine according to an embodiment of the invention.

FIG. 4 illustrates another logic flow chart showing a computer routine according to an embodiment of the invention.

FIG. 5 schematically illustrate an apparatus according to another embodiment of the invention.

### DETAILED DESCRIPTION OF THE INVENTION

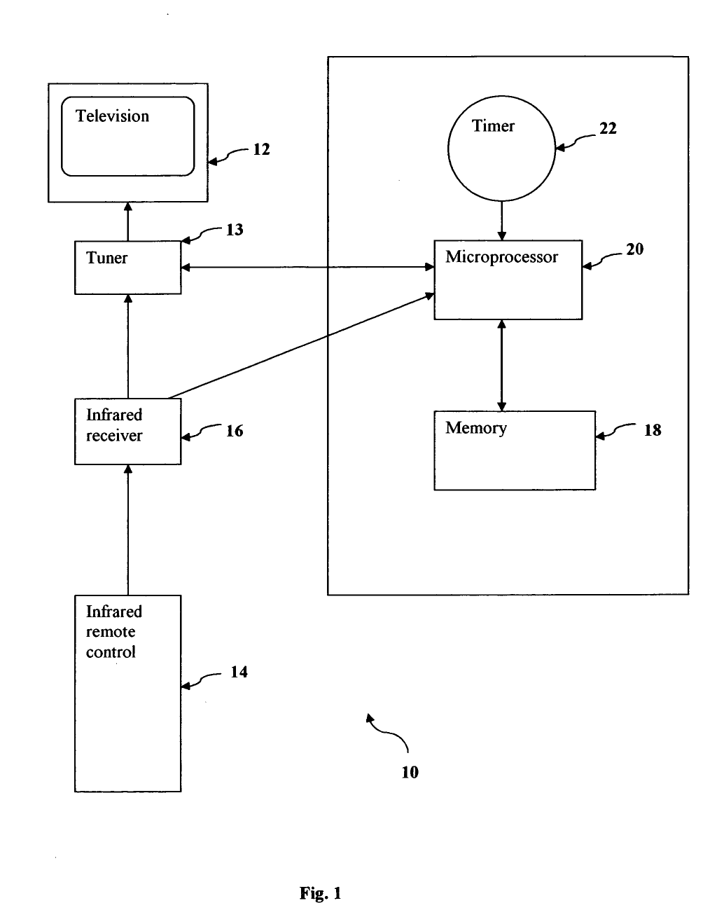

FIG. 1 shows a television apparatus 10 with computer-implemented functions. The apparatus comprises a television set 12, a tuner 13, a remote control 14, a receiver 16 for the remote control signals, a computer memory 18, a microprocessor 20, a timer 22, and computer instructions. The television set is capable of accessing and displaying a plurality of television channels, one at a time. The tuner is associated with the television set for selecting a channel to be viewed. The microprocessor is associated with the tuner for signaling the tuner to select the desired channel. The receiver is for receiving command signals from the remote control and relaying the command signals to the microprocessor. The computer memory is associated with the microprocessor for storing a historical channel data database adequate to rank the plurality of channels in order of most watched to least watched. The timer signals the microprocessor to update the database with current channel information. The computer instructions are operatively associated with the microprocessor to enable the sequential display of at least a subset of the plurality of channels, one at a time, in descending order, from most watched channel to least watched channel, or in ascending order, from least watched channel to most watched channel, responsive to command signals from the television remote control.

To reduce necessary memory resources, the channel information need not be relayed continuously. It is adequate if the timer produces a time signal once in the range of every 1 minute to 20 minutes to signal the microprocessor to produce a current channel data unit and use it to update the memory. The subset of channels preferably numbers in the range of 2 to 20 to provide the greatest benefit in time savings.

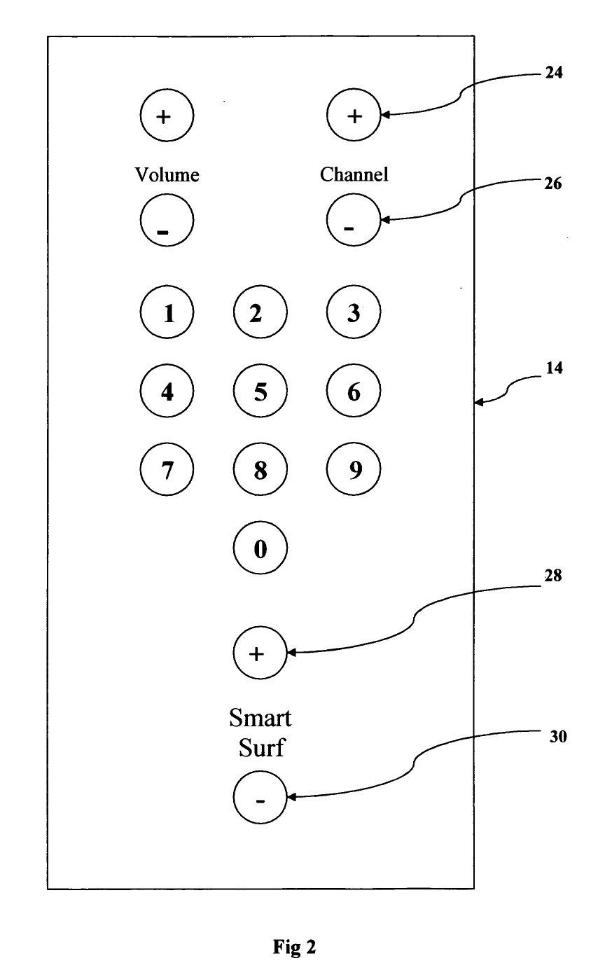

An example of a suitably configured remote control is shown in FIG. 2. A conventional set of surf buttons 24, 26 is provided for non-inventive use. A set of “smart-surf” buttons 28, 30 are provided for use according to the invention.

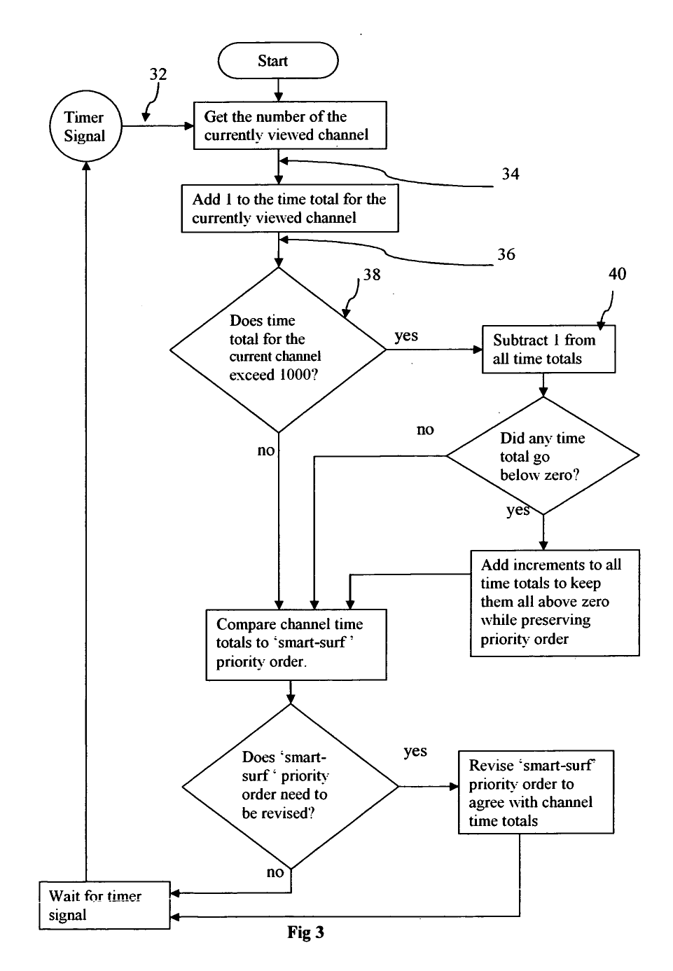

As illustrated in FIG. 2, the infrared television remote control has additional “smart-surf” up and down buttons to select channels in “smart-surf” priority order. As illustrated in FIG. 1, the infrared receiver receives infrared signals from the remote control and signals the tuner if the channels are being selected in the regular fashion, ie. by adding or subtracting 1 to the channel being viewed currently or by choosing a channel directly with the number pad. It also signals the microprocessor if the channel is being selected using the “smart-surf” buttons. The tuner chooses the channel according to a signal from the infrared receiver if the channel is being selected in the regular way, or chooses the channel according to a signal from the microprocessor, if the channel is being selected in “smart-surf” priority order. The timer (see FIG. 3) signals the microprocessor at regular intervals to prompt it to check which channel is being viewed. The microprocessor, when prompted by the timer signal, checks the tuner to see which channel is being viewed. In an exemplary embodiment, it then adds 1 to the total viewing time for the currently viewed channel, checks the total time for the current channel against the totals for the other channels to determine the “smart-surf” priority order, and revises the “smart-surf” priority order if necessary. If the “smart-surf” buttons on the remote control are being used to select channels, the microprocessor determines the appropriate channel in the “smart-surf” priority order from memory and then transmits the appropriate channel number signal to the tuner. The memory holds the “smart-surf” priority channel order list and the total viewing times, or a relative representative value, for each channel.

In various embodiments, the device can reside inside the television itself, or it can reside inside a cable set top box, or it can reside inside a satellite set top box, or it can reside inside the TV remote control.

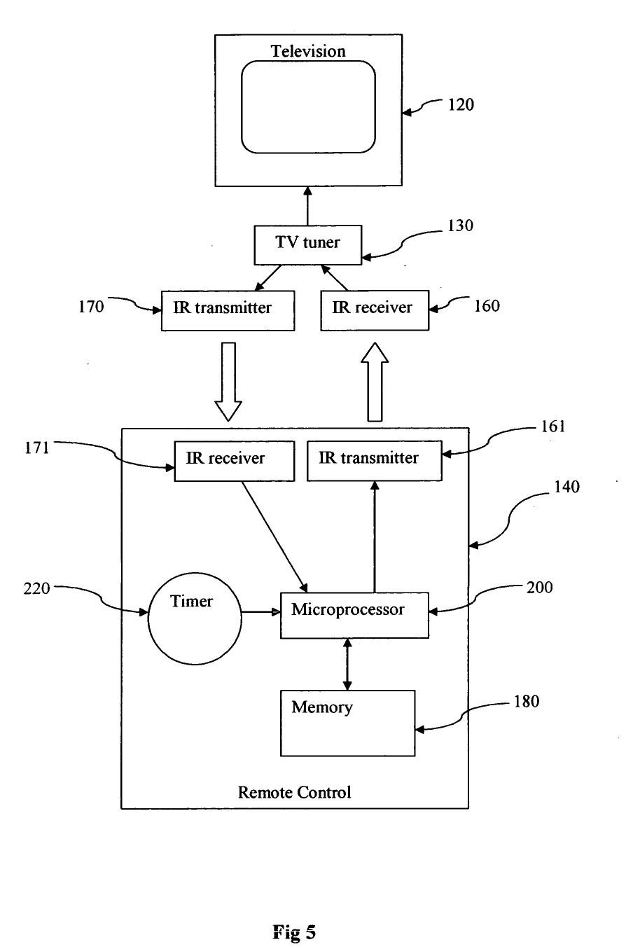

For example, the apparatus illustrated in FIG. 5 comprises a television set 120, a tuner 130, a remote control 140, a receiver 160 for the remote control signals, a computer memory 180, a microprocessor 200, a timer 220, and computer instructions. The apparatus further comprises a transmitter 170 for sending current channel signals to the remote and a receiver 171 in the remote for receiving the signals and relaying them to the microprocessor. The television set is capable of accessing and displaying a plurality of television channels, one at a time. The tuner is associated with the television set for selecting a channel to be viewed. The microprocessor is remotely associated with the tuner for signaling the tuner to select the desired channel. The receiver 160 is for receiving command signals from the remote control and relaying the command signals to the tuner. The computer memory is associated with the microprocessor for storing a historical channel data database adequate to rank the plurality of channels in order of most watched to least watched. The timer signals the microprocessor to update the database with current channel information. The computer instructions are operatively associated with the microprocessor to enable the sequential display of at least a subset of the plurality of channels, one at a time, in descending order, from most watched channel to least watched channel, or in ascending order, from least watched channel to most watched channel, responsive to command signals from the television remote control. The remote control houses the receiver 171, the microprocessor 200 and the memory 180 in addition to functionality keys as shown in FIG. 2. The timer 220 can be housed in either the remote or physically associated with the tuner.

Certain embodiments of the invention, can also be used to prioritize and select radio channels, or to prioritize a website favorites list in a web browser. Most used station or site at the top, least used at the bottom. In this case, the invention can be generically described as a method for operating a device selected from the group consisting of a television set, a radio, and an internet computer. The device has associated therewith a signal-responsive tuner for selecting a signal to be received and a detector for detecting the signal being received and producing a current signal representative of the current signal reception. The method is carried out by receiving the current signal in a data processing device, storing, in a computer memory device associated with the data processing device, historical signal data adequate to determine a most received signal for the device, determining, in the data processing device, the most received signal, and signaling the tuner to access the most received signal based on the determination. In a preferred embodiment, the device is a television set, the signal-responsive tuner is for selecting a channel, the detector is for detecting the channel being viewed and producing a current channel signal representative of such channel, the current channel signal is received in the data processing device, the historical signal data is historical channel data adequate to determine a most viewed channel for the television set and is stored in the computer memory device, the most viewed channel is determined in the data processing device, and the tuner is signaled to access the most viewed channel based on the determination.

Another embodiment of the invention provides an automated process for selecting a most viewed channel on a television set. The television set has a signal-responsive tuner for selecting a channel to be viewed and a detector for detecting the channel being viewed and produce a current channel signal representative of such channel. The current channel signal is received in a data processing device. A computer memory device associated with the data processing device receives current channel update information from the data processing device and stores historical channel data adequate to determine a most viewed channel for the television set. The most viewed channel is determined by the data processing device by accessing the historical channel data and the tuner is signaled to access the most viewed channel based on such determination.

The historical channel database is created and kept updated by the process such as that illustrated in FIG. 3. A timer signal 32 is periodically produced, such as once in the range of every 1 minute to 20 minutes. A current channel data unit 34 is produced in response to each time signal. A historical channel data database is updated with the current channel data unit to form an updated historical channel data database 36 for the channel being viewed. A determination 38 is then made as to whether the updated historical channel database exceeds a predetermined size. If so, the historical channel database is adjusted 40 for each of the channels in the event that the predetermined size is exceeded. The simplest way to form the database is in the form of a lookup table, but the necessary calculations to carry out the invention could be completed on the fly as well. Nor does the size of the database necessarily have to be limited, but it is expeditious to do so.

The computer program illustrated in FIG. 3 determines viewer channel preference by tracking how much time is spent watching each channel. These times are used to create a list of channels in preferential order from most watched to least watched. As viewing preference changes over time the list is updated to keep viewing preference current. There are, of course, many ways to solve this particular programming problem.

Since computer memory is finite, tracking cumulative total viewing time continuously is not possible. No matter how much memory space is used, eventually the stored number indicating the total accumulated viewing time will be larger than the memory can hold.

Keeping track of the exact total viewing time for each channel is not necessary. The order of the channels, from most watched to least watched, is the important part. So the object of the program is to determine, and keep updated, the channel preference order.

The programming solution is to have a maximum limit that the cumulative time totals cannot exceed. Once a cumulative time total exceeds this maximum value, the procedure switches from adding to its total and instead subtracts from all totals for all other channels. This preserves the preferential order while keeping the value of all totals at a size that is manageable for the memory.

Reducing the value of all the totals presents the problem that some of these values will be reduced to less than zero, with the consequent problem that they will eventually be too large on the negative side to be stored in memory. To prevent this problem, when any time total is reduced below zero the preferential channel order is preserved by assigning the least watched channel a cumulative time total of zero. Then the rest of the channels, from least watched to most watched, are assigned progressively larger cumulative totals, each one increasing by a set increment, to preserve preferential order. The increment of time separating the channels is set to allow a change in channel preference order after a channel has been viewed for a reasonable amount of time. Thus as viewing habits change over time the preferential viewing order is kept up to date.

The invention can also be carried out to calculate and display channel preferences taking time and day of the week into consideration, or be customized for specific users. As an example, the method can include producing a time signal which is representative of a time, and receiving the signal in the data processing device where it is associated with the current channel signal, and stored in the computer memory device to form a historical channel data database which is preferably, in essence, a record of historical viewing preferences sortable by time and day of week. In that case, the step of determining the sequence order would access the historical viewing preference data corresponding to current time and day of week, or preference data which closely corresponds.

In another embodiment of the invention, there is provided a method for surfing favorite TV channels on a television set. The television set is capable of accessing and displaying a plurality of television channels, one at a time. The television set has associated therewith a signal-responsive tuner for selecting a channel to be viewed and a detector for detecting the channel being viewed and producing a current channel signal representative of such channel. The current channel signal is received in a data processing device. A computer memory device associated with the data processing device stores channel data adequate to represent at least a subset of the plurality of television channels based on time spent viewing the channel. The subset comprises the television channels which are most viewed. The data processing device is provided with machine-readable instructions to enable the sequential display of the at least the subset of the plurality of channels, one at a time, in an ascending or descending priority sequence, based on time spent viewing the channels. A command signal is provided to the data processing device to execute the machine readable instructions and display a next channel in the priority sequence of the at least a subset of the plurality of channels in the priority sequence. Preferably the command signal is sent by a remote.

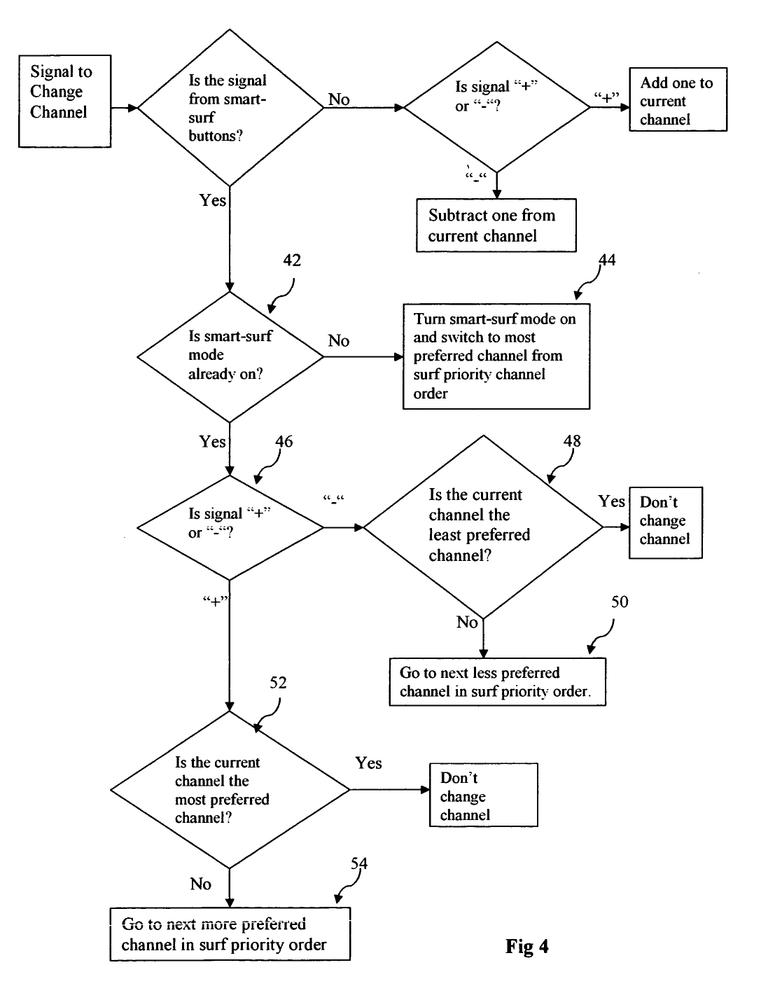

As illustrated in FIG. 4, a suitable logic for carrying out this embodiment of the invention includes a step 42 of determining whether the data processing device is already set to the smart-surf mode. If it is not already in smart-surf mode, the data processing device is then set to the smart-surf mode at 44. Also when initially entering smart-surf mode the first channel displayed is the most preferred channel.

If the determination at step 42 is that the data processing device is already in smart-surf mode, then it is determined whether the command signal is surf up favorite channels or surf down favorite channels. If it is determined that the command signal is surf down favorite channels, the process further includes the step 48 of determining whether the current channel is the least preferred channel. If it is determined that the current channel is not the least preferred channel, the process further comprises displaying the next channel in the subset in the direction of less watched channels, as illustrated at 50.

If it is determined that the command signal is surf up favorite channels, the process further comprises the step 52 of determining whether the current channel is the most preferred channel. If not, the process further comprises displaying the next channel in the subset in the direction of more watched channels as illustrated at 54.

Preferably, the at least a subset consists of a subset containing in the range of 2 to 20 favorite channels searchable from most watched to least watched, and the command signal is selected from the group consisting of smart-surf up favorite channels and smart-surf down favorite channels.

Use of the invention permits the viewer to smart-surf through channels in order from the channel he or she watches most to the channel he or she watches least. This eliminates the need to surf past channels that are of no interest to the viewer. The viewer does not need to choose the order of the channel, all he or she has to do is watch the TV programs he or she enjoys the most and the device tracks the viewing habits and creates the ordered list automatically. As viewing habits change over time, the preferentially ordered list is kept up to date automatically. All the viewer has to do is watch the TV channels he or she prefers.

The remote used in the invention could be set up with two separate buttons added to a normal remote control. One “smart-surf up” button and one “smart-surf down” button. Alternatively, It could be set up with one “smart-surf” button added to a normal remote control. The “smart-surf” button would cause the regular channel up/down buttons to select channels in the “smart-surf” order. Pressing the “smart-surf” button again would return the channel up/down buttons to their regular function. Messages such as “smart-surf on” and “smart-surf off” could be flashed on the screen momentarily, to signal what mode the channel selector buttons were in.

Many viewers of the same TV can be accommodated with their own “smart-surf” channel priority list. The device in this embodiment would simply have enough memory to store numerous priority lists, one for each viewer. Each viewer could have their own remote control. Their remote control would send an identifying signal allowing the TV to update and use the correct “smart-surf” priority list corresponding to that viewer. The “smart-surf” priority list could vary depending on day of the week and even time of day.

While certain preferred embodiments of the invention have been described herein, the invention is not to be construed as being so limited, except to the extent that such limitations are found in the claims.

What is claimed is:

1. A method for operating a device selected from the group consisting of a television set, a radio, and an internet computer, said device having associated therewith a signal-responsive tuner for selecting a signal to be received and a detector for detecting the signal being received and producing a current signal representative of said signal reception, said method comprising
receiving said current signal in a data processing device,
storing, in a computer memory device associated with the data processing device, historical signal data adequate to determine a most received signal for said device,
determining, in the data processing device, said most received signal, and
signaling the tuner to access said most received signal based on said determination.

2. A method as in claim 1 wherein
the device is a television set,
the signal-responsive tuner is for selecting a channel,
the detector is for detecting the channel being viewed and producing a current channel signal representative of such channel,
the current channel signal is received in the data processing device,
the historical signal data is historical channel data adequate to determine a most viewed channel for said television set and is stored in the computer memory device,
the most viewed channel is determined in the data processing device,
and the tuner is signaled to access said most viewed channel based on said determination, said method further comprising:
producing a time signal once in the range of every 1 minute to 20 minutes, and
producing a current channel data unit in response to each time signal.

3. A method as in claim 2 further comprising
updating the historical channel data database with the current channel data unit to form an updated historical channel data database for the channel being viewed.

4. A method as in claim 3 further comprising
determining whether the updated historical channel database exceeds a predetermined size.

5. A method as in claim 4 further comprising
adjusting the historical channel database for each of the channels in the event that the predetermined size is exceeded for the updated historical channel database.

6. A method as in claim 1 further comprising
producing, in a timer associated with the television set, a time signal representative of a time,
receiving said time signal in said data processing device,
associating, in the data processing device, said time signal with said current channel signal, and
storing, in the computer memory device, current channel data in association with time data to form a historical channel data database.

7. A method as in claim 6 wherein the historical channel data database constitutes a record of historical viewing preferences sortable by time and day of week.

8. A method as in claim 7 wherein the step of determining accesses historical viewing preference data corresponding to current time and day of week.

9. A method for operating a television set capable of accessing and displaying a plurality of television channels, one at a time, said television set having associated therewith a signal-responsive tuner for selecting a channel to be viewed and a detector for detecting the channel being viewed and producing a current channel signal representative of such channel, said method comprising
receiving said current channel signal in a data processing device,
storing, in a computer memory device associated with the data processing device, channel data adequate to represent at least a subset of said plurality of television channels based on time spent viewing the channels, said subset comprising the television channels which are most viewed,
providing the data processing device with machine readable instructions to enable the sequential display of said at least a subset of said plurality of channels, one at a time, in an ascending or descending priority sequence, based on time spent viewing the channels, and
providing a command signal to the data processing device to execute the machine readable instructions and display a next channel of the at least a subset of the plurality of channels in the priority sequence.

10. A method of operating a television set as in claim 9 wherein the at least a subset consists of a subset containing in the range of 2 to 20 favorite channels searchable from most watched to least watched.

11. A method as in claim 10 wherein the command signal is selected from the group consisting of smart-surf up favorite channels and smart-surf down favorite channels.

12. A method as in claim 11 further comprising
determining whether the data processing device is set in a smart-surf favorite channel mode.

13. A method as in claim 12 wherein it is determined that the data processing device is not set in a smart-surf favorite channel mode, said process further comprising
setting the data processing device in a smart-surf favorite channel mode, and
displaying the most watched channel.

14. A method as in claim 12 wherein it is determined that the data processing device is set in a smart-surf favorite channel mode, said process further comprising
determining whether the command signal is smart-surf up favorite channels or smart-surf down favorite channels.

15. A method as in claim 14 wherein it is determined that the command signal is smart-surf down favorite channels, said process further comprising
determining whether the current channel is the least preferred channel.

16. A method as in claim 15 wherein it is determined that the current channel is not the least preferred channel, said process further comprising
displaying the next channel in the subset in the direction of less watched channels.

17. A method as in claim 14 wherein it is determined that the command signal is smart-surf up favorite channels, said process further comprising
determining whether the current channel is the most preferred channel.

18. A method as in claim 17 wherein it is determined that the current channel is not the most preferred channel, said process further comprising
displaying the next channel in the subset in the direction of more watched channels.

19. Apparatus comprising
a television set capable of accessing and displaying a plurality of television channels, one at a time,
a signal responsive tuner associated with the television set for selecting a channel to be viewed,
a microprocessor associated with the tuner for signaling the tuner to select a desired channel to be viewed,
a television remote control,
a receiver for receiving command signals from the remote control and relaying the command signals to the microprocessor,
a computer memory associated with the microprocessor for storing a historical channel data database adequate to rank the plurality of channels in order of most watched to least watched,
a timer to signal the microprocessor to update the database with current channel information, and
computer instructions operatively associated with the microprocessor to enable the sequential display of at least a subset of said plurality of channels, one at a time, in descending order, from most watched channel to least watched channel, or in ascending order, from least watched to most watched channel responsive to command signals from the television remote control.

20. Apparatus as in claim 19 wherein the timer, the microprocessor and computer memory are housed in the remote control.
